(19) United States
(12) Patent Application Publication
(10) Pub. No.: US 2017/0185986 A1
(43) Pub. Date: Jun. 29, 2017

(54) INFORMATION PROCESSING DEVICE, INFORMATION PROCESSING SYSTEM, AND CONTROL METHOD OF AN INFORMATION PROCESSING DEVICE

(71) Applicant: Seiko Epson Corporation, Tokyo (JP)

(72) Inventors: Koji NISHIZAWA, Shiojiri-shi (JP); Moonhee LEE, Matsumoto-shi (JP)

(73) Assignee: Seiko Epson Corporation, Tokyo (JP)

(21) Appl. No.: 15/391,225

(22) Filed: Dec. 27, 2016

(30) Foreign Application Priority Data
Dec. 28, 2015 (JP) 2015-256744

(51) Int. Cl. G06Q 20/20

(52) U.S. Cl. CPC G06Q 20/209

(57) ABSTRACT

Printed information can be accurately analyzed. A control server 15 that receives and processes text data, which is printed information from a printer, has a control server controller that generates words from the text data based on break characters contained in the text data; generates word groups of plural words based on the relative positions before and after the words; and based on the relative positions of the words or word groups, groups the words or word groups into items.

### CROSS-REFERENCE TO RELATED APPLICATIONS

This application claims priority under 35 U.S.C. §119 to Japanese Patent Application No. 2015-256744 filed on Dec. 28, 2015, the entire disclosure of which is expressly incorporated by reference herein.

### BACKGROUND

1. Technical Field

The present invention relates to an information processing device, an information processing system, and a control method of an information processing device.

2. Related Art

Technology for converting data output from the transaction processing unit of a point of sale (POS) terminal to a data format that can be understood by an external device, sending the converted data to the external device, and managing the transmitted data on the external device is described in, for example, JP-A-2012-27633.

At a POS terminal that runs processes based on transactions, such as the POS terminal described in JP-A-2012-27633, either the POS terminal has printing capability and prints receipts, or a printer connected to the POS terminal prints receipts, based on the transactions. Various information, including information related to the transactions, is printed on the receipts. The information printed on the receipts may also include valuable information that can be used in other ways, but the technology of the related art is unable to appropriately analyze the printed information.

### SUMMARY

At least one exemplary objective of the present invention is to enable appropriately analyzing printed information.

An information processing device according to at least one exemplary embodiment of the invention processes text data, which is information to be printed; separates the information contained in the text data into words; and based on the relative positions of the words, itemizes the words or word groups of plural words. The information processing device has a communicator configured to communicate with a printing device; and a controller configured to generate words from text data received from the communicator based on break characters contained in the text data, generate word groups containing multiple words based on the relative positions before and after the words, and group the words or word groups into items based on the relative positions of the words or word groups; the text data containing print information that is printed by the printing device.

This configuration breaks the information contained in the text data into words, and the resulting words or word groups are appropriately itemized based on the relative positions of the words in the text data. As a result, after correlating the words or word groups to specific items and item values, the words or word groups can be interpreted and used as item values corresponding to specific items, and the printed information can be appropriately analyzed.

In another aspect of at least one exemplary embodiment of the invention, the text data contains receipt information that is printed as a receipt by the printing device; the information processing device has storage configured to store specific rules for itemizing the words or word groups based on the receipt; and the controller itemizes the words or word groups based on the rules stored in the storage.

This configuration stores rules about layouts customarily used when printing a receipt, and the words or word groups in the receipt information received from the printing device that prints the receipts are appropriately itemized based on the rules. As a result, after correlating the words or word groups to specific items and item values, the words or word groups can be interpreted and used as item values corresponding to specific items, and the printed information can be appropriately analyzed.

In another aspect of at least one exemplary embodiment of the invention, the controller itemizes the words or word groups based on the data types of the words.

This configuration enables using the data type of words to more appropriately group the words or word groups into items.

In another aspect of at least one exemplary embodiment of the invention, based on the result of itemizing the words or word groups, the controller generates analytical data relating the words or word groups to items and item values in a hierarchy of items.

This configuration enables later using the analytical data to run processes using the itemized words or word groups.

In another aspect of at least one exemplary embodiment of the invention, the text data is data written according to a specific layout; and the controller generates layout information based on the result of itemizing the words or word groups. The layout information is information related to a specific layout corresponding to the text data, and is information that can be used to itemize the words or word groups of the text data in the specific layout.

After generating the layout information, this configuration enables more easily itemizing the words or word groups based on the layout information.

In another aspect of at least one exemplary embodiment of the invention, after itemizing the words or word groups, the controller determines if the words or word groups related as the item value of one item, and the words or word groups related to the item value of another item, are in a specific relationship.

As a result, the controller can detect when the words or word groups are not correctly itemized.

In another aspect of at least one exemplary embodiment of the invention, the controller itemizes the words or word groups based on the position in the line to which the words or word groups belong.

This configuration enables using the location of the line to accurately separate the information in the text data into words.

Another aspect of at least one exemplary embodiment of the invention is an information processing system including: a printing device having a printing function, and transmitting text data containing print information to be printed, and an information processing device configured to receive the text data from the printing device. The information processing device has a controller configured to generate words from the text data received from the printing device based on break characters contained in the text data, generate word groups containing multiple words based on the relative positions before and after the words, and group the words or word groups into items based on the relative positions of the words or word groups. The text data contains print information that is to be printed by the printing device.

This configuration breaks the information contained in the text data into words, and the resulting words or word groups are appropriately itemized based on the relative positions of the words in the text data. As a result, after correlating the words or word groups to specific items and item values, the words or word groups can be interpreted and used as item values corresponding to specific items, and the printed information can be appropriately analyzed.

Another aspect of at least one exemplary embodiment of the invention is a control method of an information processing device that can communicate with a printing device, including: receiving text data from the printing device; generating words based on break characters contained in the text data; generating word groups containing multiple words based on the relative positions before and after the words; and grouping the words or word groups into items based on the relative positions of the words or word groups. The text data contains print information that is printed by the printing device.

This configuration breaks the information contained in the text data into words, and the resulting words or word groups are appropriately itemized based on the relative positions of the words in the text data. As a result, after correlating the words or word groups to specific items and item values, the words or word groups can be interpreted and used as item values corresponding to specific items, and the printed information can be appropriately analyzed.

Other objects and attainments together with a fuller understanding of the exemplary embodiments of the invention will become apparent and appreciated by referring to the following description and claims taken in conjunction with the accompanying drawings.

### BRIEF DESCRIPTION OF THE DRAWINGS

FIG. 1 illustrates the configuration of a transaction processing system according to an exemplary embodiment of the invention.

FIG. 2 is a block diagram illustrating the functional configuration of devices in the transaction processing system.

FIG. 3 is a flow chart illustrating the operation of a tablet terminal, printing device, and control server.

FIG. 4A shows an example of a receipt.

FIG. 4B shows another example of a receipt.

FIG. 5A shows an example of printed text data.

FIG. 5B shows another example of printed text data.

FIG. 6 shows an example of the structure of a text data manager database.

FIG. 7 is a flow chart of an operation of the control server.

FIG. 8A shows examples of word data.

FIG. 8B shows other examples of word data.

FIG. 9A shows examples of line data.

FIG. 9B shows other examples of line data.

FIG. 10A shows examples of area data.

FIG. 10B shows other examples of area data.

FIG. 11 shows an example of analyzed data.

FIG. 12 shows an example of a transaction information manager database.

### DETAILED DESCRIPTION

One embodiment of the present invention is described below with reference to the accompanying figures.

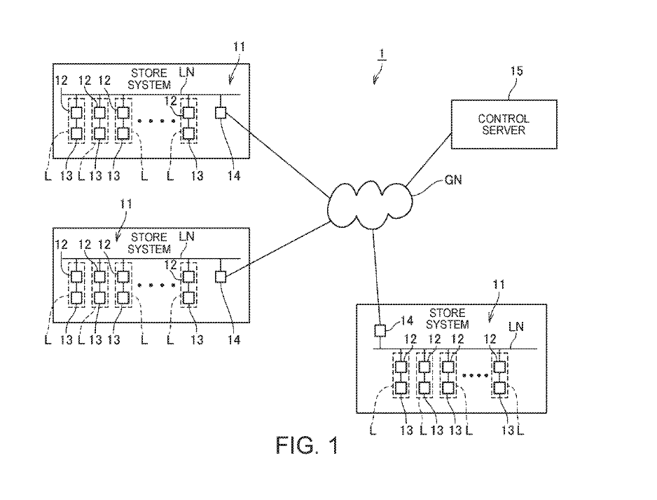

FIG. 1 shows the configuration of a transaction processing system 1 (information processing system) according to an exemplary embodiment of the invention.

As shown in FIG. 1, the transaction processing system 1 includes a plurality of store systems 11. A store system 11 is a system that is used in businesses including retail businesses such as supermarkets, convenience stores, department stores, and restaurants. The business may be any facility in which a product is sold and a customer transaction is performed according to the sale of the product. In this embodiment, the product is not limited to a physical product supplied to the customer, and means any product that is provided to a customer in exchange for payment, including, for instance, services provided to customers and food or drink provided to customers.

The store system 11 has and/or performs functions for processing transactions according to the products purchased by customers, and producing receipts based on the transactions.

A counter L where customer transactions are processed is located in the business where the store system 11 is deployed. A printer 12 capable of recording on roll paper (recording media) is installed at the counter L. A tablet terminal 13 that connects and communicates wirelessly with the printer 12 and controls the printer 12 is also disposed at the counter L.

During a transaction at the counter L, the cash register operator, using the barcode reader BR connected to the printer 12, reads or scans barcodes from the products or product packaging, inputs or causes inputting information related to the transaction to the tablet terminal 13. The printer 12 sends data based on reading with the barcode reader BR to the tablet terminal 13. Based on the data acquired by reading with the barcode reader BR and received from the printer 12, and transaction-related input from the operator, the tablet terminal 13 causes the printer 12 to produce a receipt. The receipt produced by the printer 12 can then be given by the operator to the customer.

The configuration, functions, and processes based on the functions of the printer 12 and tablet terminal 13 are described in further detail below.

A local area network LN is deployed in the store system 11.

The printer 12 connects to the local area network (LAN) LN using a communication protocol used by the LAN.

A communication device 14 is also connected to the local area network LN. The communication device 14 is an interface device that connects to the local area network LN and a global network GN such as the Internet, telephone network, and/or other communication networks. The communication device 14 has the functions of a modem (or ONU (optical network unit)), a router, a NAT (network address translation) unit, and a DHCP (dynamic host configuration protocol) server. The communication device 14 transfers data that is sent and received between devices when a device connected to the local area network LN and a device connected to the global network GN communicate with each other. Although the communication device 14 is represented by a single block in FIG. 1, but the communication device 14 may comprise plural devices with different functions.

The printer 12 can also access the global network GN through the communication device 14.

A control server 15 (information processing device) is connected to the global network GN. The control server 15 is a cloud server in a cloud system in which the printer 12 is a client. More specifically, when triggered by a request from a client, for example, the control server 15 runs a specific process described below. The control server 15 sends data based on the result of the process to the client as needed. Note that the control server 15 is represented by a single block in FIG. 1, but this does not mean that the control server 15 is embodied by a single server device. For example, the control server 15 may comprise a plurality of server devices. More specifically, the control server 15 may be configured in any way enabling executing the processes described below.

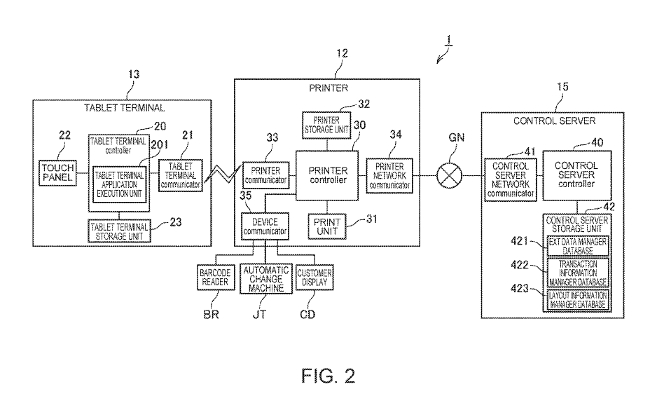

FIG. 2 is a block diagram illustrating the functional configuration of devices in the transaction processing system 1.

The tablet terminal 13 is a tablet (flat panel) computer with a touch panel 22 covering an area on the front of the tablet. When a transaction is processed at the counter L, the tablet terminal 13 functions as a host computer that runs transaction-related processes and controls the printer 12.

As shown in FIG. 2, the tablet terminal 13 includes a tablet terminal controller 20, a tablet terminal communicator 21, a touch panel 22, and a tablet terminal storage unit 23.

The tablet terminal controller 20 includes a CPU, ROM, RAM, and other peripheral circuits, and controls the tablet terminal 13. A specific application (“tablet terminal application TAP” below) is installed or preinstalled in ROM or other memory on the tablet terminal 13. The CPU of the tablet terminal controller 20 functions as a tablet terminal application execution unit 201 by reading and running the tablet terminal application TAP and associated programs.

The tablet terminal communicator 21 communicates with the printer 12 according to a specific communication protocol as controlled by the tablet terminal controller 20. The wireless communication standard for wireless communication between the tablet terminal 13 and printer 12 may be, for example, a wireless LAN standard compatible with an ad hoc mode, a wireless LAN standard compatible with an infrastructure mode, or a near-field communication standard such as Bluetooth®.

The touch panel 22 combines an LCD panel or other type of display panel, and a touch sensor overlaid on the display panel. The display panel displays images as controlled by the tablet terminal controller 20. The touch sensor detects touch operations by the user and outputs to the tablet terminal controller 20. The tablet terminal controller 20 then executes processes according to the touch operation based on input from the touch sensor.

The tablet terminal storage unit 23 has flash ROM or other nonvolatile memory, and stores data.

The printer 12 is a thermal line printer that holds roll paper and forms dots on the stored roll paper with a line thermal head to print images.

As shown in FIG. 2, the printer 12 has a printer controller 30, print unit 31 (printing mechanism), printer storage unit 32, printer communicator 33, printer network communicator 34, and device communicator 35.

The printer controller 30 includes a CPU, ROM, RAM, and other peripheral circuits, and controls parts of the printer 12 by the CPU reading and running firmware or other program stored in ROM or other memory.

The print unit 31 includes mechanisms related to printing on roll paper, such as a conveyance mechanism for conveying roll paper stored inside the cabinet of the printer 12, a printing mechanism for forming dots and printing images on the roll paper with a thermal head, and a cutter mechanism for cutting the roll paper at a specific position. As controlled by the printer controller 30, the print unit 31 conveys the roll paper with the conveyance mechanism while printing receipt-related images on the roll paper by the printing mechanism, and then cuts the roll paper at a specific position with the cutter mechanism, thereby producing a receipt.

The printer storage unit 32 has flash ROM or other nonvolatile memory, and stores data.

The printer communicator 33 communicates with the tablet terminal 13 according to a specific communication protocol as controlled by the printer controller 30.

The printer network communicator 34 communicates with devices connected to the global network GN (including the control server 15) according to a specific communication protocol as controlled by the printer controller 30.

The device communicator 35 includes an interface board with ports such as a USB port, a serial communication port other than a USB port, or other type of port. A device can connect to each port. The device communicator 35 communicates with the devices connected to the printer 12 through the ports as controlled by the printer controller 30.

It should be understood that the device communicator 35 may be configured with wireless communication capabilities for communicating wirelessly with devices.

A barcode reader BR, customer display CD, and an automatic change machine JT are examples of devices connected to the tablet terminal 13 in this example.

The barcode reader BR is used to read barcodes from products and product packaging, and outputs the read result to the device communicator 35. The device communicator 35 outputs the data input from the barcode reader BR to the printer controller 30.

The customer display CD displays transaction-related information as controlled by the printer controller 30. The information presented on the customer display CD can be checked by the customer involved in the transaction at the counter L.

The automatic change machine JT has cash receiver openings for receiving cash inserted by the customer and cash dispenser openings for dispensing change based on the amount received. When cash is input through the cash receiver, the change due is dispensed from the cash return openings as controlled by the printer controller 30.

The control server 15 is a cloud server of which the printer 12 is a client.

As shown in FIG. 2, the control server 15 includes a control server controller 40 (control unit; controller), control server network communicator 41, and control server storage unit 42 (storage unit).

The control server controller 40 includes a CPU, ROM, RAM, and other peripheral circuits, and controls the control server 15. The CPU reads and runs programs stored in ROM or other memory, and controls other parts of the control server 15.

The control server network communicator 41 communicates with devices connected to the global network GN (including printers 12) according to a specific communication protocol as controlled by the control server controller 40.

The control server storage unit 42 stores data, including a text data manager database 421, a transaction information manager database 422, and a layout information manager database 423.

The processes run by the tablet terminal 13, printer 12, and control server 15 when a transaction is processed at the counter L are described next.

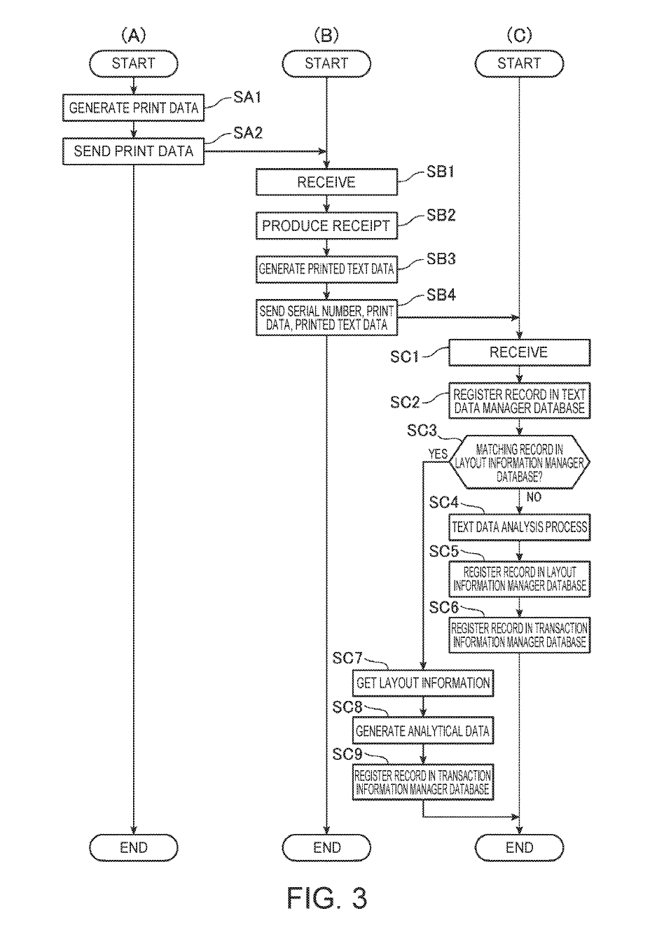

FIG. 3 is a flow chart of the operation of the tablet terminal 13, printer 12, and control server 15 when processing a transaction at the counter L. FIG. 3, column (A) describes the process of the tablet terminal 13, FIG. 3, column (B) describes the process of the printer 12, and FIG. 3, column (C) describes the process of the control server 15.

As shown in FIG. 3, column (A), the tablet terminal application execution unit 201 of the tablet terminal controller 20 of the tablet terminal 13 executes a transaction process (payment process) appropriately to the products purchased by the customer, and generates print data based on the transaction process (step SA1).

More specifically, in step SA1, the tablet terminal application execution unit 201 executes the transaction process based on input from the printer 12 (the barcode reader BR connected to the printer 12) and input from the operator via the touch panel 22 based on the products purchased by the customer. The tablet terminal application execution unit 201 generates receipt information. The receipt information is information the printer 12 prints on the produced receipt. Examples of the specific content of the receipt information are described below.

Next, the tablet terminal application execution unit 201 generates print data based on the generated receipt information. The print data includes control commands instructing producing a receipt with the receipt information printed according to a specific layout. The print data includes plural control commands in the command language of the printer 12.

After generating the print data in step SA1, the tablet terminal application execution unit 201 controls the tablet terminal communicator 21 to send the generated print data to the printer 12 (step SA2).

As shown in FIG. 3, column (B), the printer controller 30 of the printer 12 controls the printer communicator 33 to receive the print data (step SB1).

Next, the printer controller 30 controls the print unit 31 to produce a receipt based on the print data received in step SB1 (step SB2). The resulting receipt can be given to the customer.

A receipt produced by the printer 12 in the store has the following characteristics. Specifically, the layout of receipts produced by the printers 12 in a single POS system is the same unless there is a change in the tablet terminal application TAP. The layout of receipts produced by printers 12 contained in one POS system, and the layout of receipts produced by printers 12 in a POS system different from the one POS system containing the other printers 12, may differ. The layout of receipts produced by different businesses using the same POS system may also differ. In other words, the layouts of the produced receipts may differ depending on the specific printer 12.

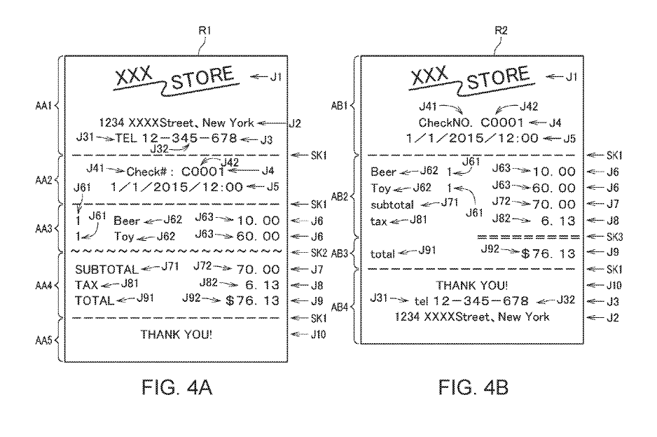

FIG. 4A shows receipt R1 as an example of a receipt produced by a printer 12 based on the print data. FIG. 4B shows a receipt R2 as an example of a receipt with a layout different from the layout of the receipt R1 shown in the example in FIG. 4A.

The content of the information printed on the receipt R1 in FIG. 4A, and the content of the information printed on the receipt R1 in FIG. 4B, contain the same purchased product and price information.

Logo information J1 as a graphical representation of the name of the store is printed at the top of the receipt R1 in FIG. 4A.

Store address information J2 indicating the address of the store is recorded below the logo information J1 on the receipt R1.

Store telephone number related information J3, which is a text string expressing information related to the telephone number of the store, is printed on the next line after the store address information J2. The store telephone number related information J3 includes store telephone number information J32, which indicates the telephone number of the business. The store telephone number related information J3 also includes a telephone number identifier J31, which is printed at the left side on the same line as the store telephone number information J32, and which is information indicating that the store telephone number information J32 contains the telephone number. As shown in FIG. 4A, the telephone number identifier J31 of receipt R1 is a string of the three capital letters TEL.

On the line following the store telephone number related information J3 in the receipt R1 is printed first area break information SK1. The first area break information SK1 is a string of multiple hyphens (-) on the same line.

The print areas of the receipt R1 are separated by the first area break information SK1. The first area break information SK1 separates the area thereabove from the following content. Below, the area above the first area break information SK1 in receipt R1 is referred to as area AA1.

Receipt identification related information J4 identifying the receipt is printed on the line following the first area break information SK1 on the receipt R1. The receipt identification related information J4 contains receipt identification information J42 identifying the receipt. The receipt identification related information J4 contains a receipt identification identifier J41, which is printed at the left side on the same line as the receipt identification information J42, and which is information indicating that the receipt identification information J42 is information identifying the receipt.

As shown in FIG. 4A, the receipt identification identifier J41 of the receipt R1 is information starting with the string “Check#”.

On the line following the receipt identification related information J4 in the receipt R1 is printed a time stamp J5 indicating the date and time the receipt was printed.

Area break information SK1 is then printed below the time stamp J5.

The first area break information SK1 and the second area break information SK1 on the receipt R1 define another print area in which specific information is printed. The area of the receipt R1 between the first area break information SK1 and the second area break information SK1 is referred to below as area AA2.

Starting from the line following the second area break information SK1 in the receipt R1 is printed one or more lines of transaction detail information J6 (two lines shown in FIG. 4A).

The detail information J6 is information related to the products purchased by the customer. The detail information J6 is printed on the receipt R1 for each type of product purchased by the customer. Therefore, if the customer purchased three different products, three lines of detail information J6 are printed, one for each product type. When multiple lines of detail information J6 are printed on a receipt R1, the multiple lines of detail information J6 are consecutively printed to different lines.

The detail information J6 contains on each line purchased quantity information J61, product name information J62, and price information J63. The purchased quantity information J61 is information expressing the quantity (count) of the corresponding product as an integer (without a decimal point). The product name information J62 is information expressing the name of the corresponding product as a text string. The price information J63 is information expressing the price of the corresponding product as a value that in this example includes a decimal point.

The purchased quantity information J61, product name information J62, and price information J63 contained in the detail information J6 are printed on one line of the receipt R1 from left to right in the order purchased quantity information J61->product name information J62->and price information J63.

On the line following the last line of printed detail information J6 on the receipt R1 is second area break information SK2. The second area break information SK2 is a string of multiple tilde (˜) characters printed consecutively on one line.

The print area of the receipt R1 is segmented by the second area break information SK1 and the first second area break information SK2, and the area between the second area break information SK1 on the receipt R1 and the first second area break information SK2 is referred to below as area AA3.

Subtotal related information J7 is printed on the receipt R1 on the line following the first second area break information SK2. The subtotal information J7 contains subtotal information J72. The subtotal related information J7 also contains a subtotal identifier J71, which is printed to the left on the same line as the subtotal information J72, and indicates that the subtotal information J72 contains information indicating the transaction subtotal.

As shown in FIG. 4A, the subtotal identifier J71 is an eight character string of the capital letters SUBTOTAL.

On the line following the subtotal related information J7 of the receipt R1 is printed tax related information J8. The tax related information J8 includes tax information J82 showing the amount of tax. The tax related information J8 also contains a tax information identifier J81, which is printed on the left on the same line as the tax information J82 and indicates that the tax information J82 contains the amount of tax.

As shown in FIG. 4A, the tax information identifier J81 of the receipt R1 is a string containing the three capital letters TAX.

Transaction total related information J9 is printed on the line following the tax related information J8 on the receipt R1. The transaction total related information J9 contains transaction total information J92 indicating the transaction total. The transaction total related information J9 also contains a transaction total identifier J91, which is printed on the left on the same line as the transaction total information J92 and indicates that the transaction total information J92 contains the transaction total.

As shown in FIG. 4A, the transaction total identifier J91 of the receipt R1 is a string containing the five capital letters spelling the word “TOTAL.”

Third area break information SK1 is printed on the receipt R1 on the line following the transaction total related information J9.

The print area of the receipt R1 is segmented by the first second area break information SK2 and the third area break information SK1, and the area of the receipt R1 between the first second area break information SK2 and the third area break information SK1 is referred to below as area AA4. The area below the third area break information SK1 is referred to below as area AA5.

Additional information J10 is printed on the receipt R1 on the line following the third area break information SK1. The additional information J10 in this example is a string expressing thanks to the customer receiving the receipt.

When not differentiated, the area break information SK1, second area break information SK2, and third area break information SK3 described below are referred to as area break information.

Information is thus printed on receipt R1 using the following layout. That is, four instances of area break information are printed in the print area of the receipt R1, and the print area of the receipt is divided from the top by these four area break information instances into five different areas referred to as area AA1, area AA2, area AA3, area AA4, and area AA5.

In area AA1 are sequentially printed the logo information J1, store address information J2, and store telephone number related information J3.

In area AA2 are sequentially printed the receipt identification related information J4 and time stamp J5.

In area AA3 is printed one or more lines of detail information J6. The purchased quantity information J61, product name information J62, price information J63 contained in the detail information J6 are printed on one line from left to right in the order purchased quantity information J61->product name information J62->price information J63.

In area AA4 are sequentially printed the subtotal related information J7, tax related information J8, and transaction total related information J9.

Additional information J10 is printed in area AA5.

As described above, while the products purchased by each customer will vary, each receipt R1 produced by the printer 12 is printed using the same layout as receipt R1 described above.

A receipt R2 shown in the example in FIG. 4B also starts with logo information J1 at the top.

Below the logo information J1 on the receipt R2 is printed receipt identification related information J4. The receipt identification related information J4 contains a receipt identification identifier J41 and receipt identification information J42.

As shown in FIG. 4B, the receipt identification identifier J41 of the receipt R2 is information starting with the string “CheckNO”. This string is different from the string printed as the receipt identification identifier J41 on receipt R1.

On the line following the receipt identification related information J4 in the receipt R2 is printed a time stamp J5.

Area break information SK1 is then printed below the time stamp J5.

The receipt R2 is segmented by the first area break information SK1 into areas above and below the area break information SK1. The area of the receipt R2 above the area break information SK1 is referred to below as area AB1.

Starting from the line following the area break information SK1 in the receipt R2 is printed consecutively on different lines one or more lines of transaction detail information J6 (two lines shown in FIG. 4B).

The purchased quantity information J61, product name information J62, price information J63 contained in the detail information J6 are printed on one line of the receipt R1 from left to right in the order purchased quantity information J61->product name information J62->and price information J63.

Subtotal related information J7 is printed on the receipt R2 on the line following the last line of detail information J6.

As shown in FIG. 4B, the subtotal identifier J71 of receipt R2 is an eight character string of the lowercase letters subtotal, and thus differs from the subtotal identifier J71 printed on receipt R1.

On the line following the subtotal related information J7 of the receipt R2 is printed tax related information J8. As shown in FIG. 4B, the tax information identifier J81 of this receipt R2 is a three character string of the lowercase letters “tax”, and thus differs from the tax information identifier J81 printed on receipt R1.

On receipt R2, third area break information SK3 is printed on the line following the tax related information J8. The third area break information SK3 is a string of multiple equal signs (=) printed consecutively on one line.

The print area of receipt R2 is segmented by the first area break information SK1 and the first third area break information SK3 into different areas, and the area between the first area break information SK1 and the first third area break information SK3 is referred to below as area AB2.

On receipt R2, the transaction total related information J9 is printed on the line following the third area break information SK3. As shown in FIG. 4B, the transaction total identifier J91 of the receipt R1 is a string containing the five lowercase letters total, and thus differs from the transaction total identifier J91 printed on receipt R1.

A second instance of area break information SK1 is printed on the receipt R2 on the line following the transaction total related information J9.

The print area of the receipt R2 is segmented by the first third area break information SK3 and the second area break information SK1, and the area between the first third area break information SK3 and the second area break information SK1 on the receipt R2 is referred to below as area AB3. The area below the second area break information SK1 is referred to below as area AB4.

Additional information J10 is printed on the receipt R2 on the line following the second area break information SK1.

On receipt R2, the store telephone number related information J3 is printed on the line below the additional information J10. As shown in FIG. 4B, the telephone number identifier J31 of receipt R2 is a string of the three lowercase letters “tel”, and the string thus differs from the telephone number identifier J31 on receipt R1 above.

The store address information J2 is printed on the line below the store telephone number related information J3 on receipt R2.

Information is thus printed in the layout described below on receipt R2. Specifically, three instances of area break information are printed in the print area of the receipt R2, and these three instances of area break information divide the print area from the top into four areas, area AB2, area AB2, area AB3, and area AB4.

In area AB1 are sequentially printed logo information J1, receipt identification related information J4, and a time stamp J5.

In area AB2 are sequentially printed one or more lines of detail information J6, subtotal related information J7, and tax related information J8.

In area AB3 is printed the transaction total related information J9.

In area AB4 are sequentially printed additional information J10, store telephone number related information J3, and store address information J2.

As described above, while the products purchased by each customer will vary, each receipt R2 produced by the printer 12 is printed using the same layout as receipt R2 described above.

As will be obvious by comparing FIG. 4A and FIG. 4B, the layouts of receipt R1 and receipt R2 differ.

As shown in FIG. 3, column (B), after producing a receipt in step SB2, the printer controller 30 generates printed text data (text data) based on the print data (step SB3). The process of step SB3 is described next.

The printed text data is text data containing the text (character codes) of the information that is printed as text (characters) in the information that is printed based on the print data.

In one embodiment of the invention, control commands (“print string instruction” below) that contain one or more character codes and instruct printing text based on the character codes can be contained in the print data. Information specifying styling to apply to the characters printed based on a print string instruction may also be contained in the print string instructions. Styles that may be applied to the text (characters) include, for example, bolding, underlining, adding emphasis, inverting black and white, rotation, right justification, center justification, and left justification. The printer storage unit 32 of the printer 12 stores a font table containing the character codes and font data corresponding to the characters identified by the character codes.

Based on a print string instruction, the printer controller 30 of the printer 12 has the capability to convert each of the character codes contained in the command to the corresponding font data, render the font data as image data in RAM or other image buffer to reflect the styling specified by the command corresponding to the font data, and based on the image data rendered in the image buffer, and print the characters. The image data is in a format that can be printed by the printhead of the print unit 31.

In step SB3, the printer controller 30 extracts control commands related to printing strings, such as the print string instructions and carriage return commands instructing a carriage return, from the print data. Next, the printer controller 30, based on specific control commands such as carriage return commands contained in the extracted control commands, generates printed text data, which is the information printed as characters on the receipt written as text.

The information in the printed text data is written in a format reflecting the carriage returns executed when printing.

The information in the printed text data does not reflect any styling specified by the print string instructions. As a result, if center justification or right justification is specified as styling to apply to some text in the print string instructions, this styling is not reflected when recording the characters in the printed text data.

Note that a space character (also referred to as a space or blank) is also a character to which a character code is assigned, and space characters are also recorded in the printed text data.

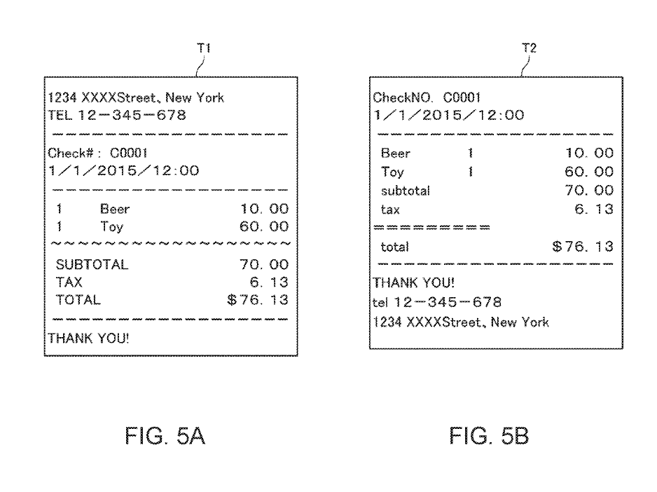

FIG. 5A shows an example of the content of printed text data T1 that is generated based on the print data for the receipt R1 shown in FIG. 4A when the printed text data T1 is stored in RAM or other memory. As will be obvious from comparing FIG. 4A and FIG. 5A, the information printed as text in receipt R1 is written in the printed text data T1 in the same printed order and reflecting the locations of the carriage returns in the printed receipt R1.

FIG. 5B shows an example of the content of printed text data T2 that is generated based on the print data for the receipt R2 shown in FIG. 4B when the printed text data T2 is stored in RAM or other memory. As will be obvious from comparing FIG. 4B and FIG. 5B, the information printed as text in receipt R2 is written in the printed text data T2 in the same printed order and reflecting the locations of the carriage returns in the printed receipt R2.

Note that the logo information J1 is not information that is printed based on character codes, and more specifically is information that is printed based on graphic image data, such as bitmap data. As shown in FIG. 5A and FIG. 5B, information other than the information printed based on font data corresponding to character codes is not recorded in the printed text data.

Next, as shown in FIG. 3, column (B), after generating the printed text data in step SB3, the printer controller 30 sends a serial number J11, the print data received in step SB1, and the printed text data generated in step SB3, to the control server 15 (step SB4).

The serial number J11 is identification information uniquely assigned to the printer 12 when the printer 12 is manufactured.

Note that in step SB4, information related to communication required to transmit the serial number J11 (information related to the destination, the protocol used for communication, and the format of the transmitted data, for example) is previously registered in the printer storage unit 32 of the printer 12.

As shown in FIG. 3, column (C), the control server controller 40 of the control server 15 controls the control server network communicator 41 to receive the serial number J11, the print data, and the printed text data that were transmitted by the printer 12 (step SC1).

Next, the control server controller 40 creates a record in the text data manager database 421 (step SC2).

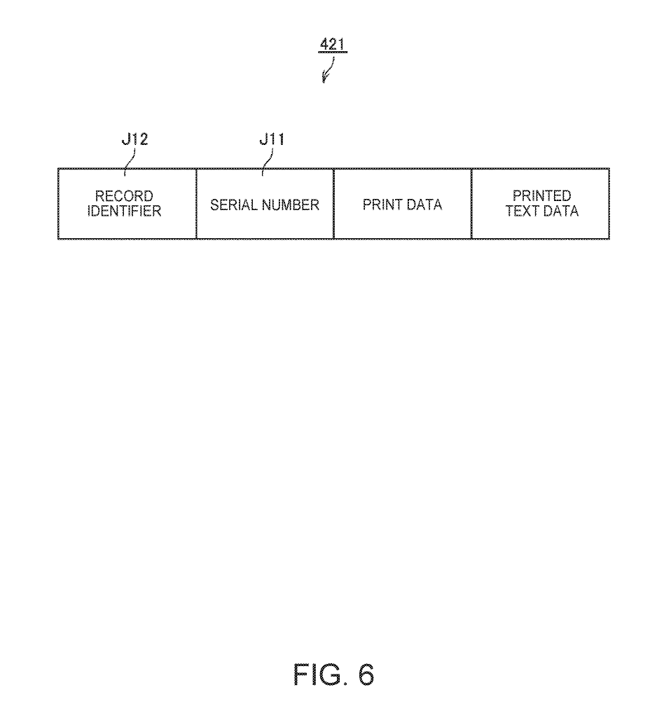

FIG. 6 illustrates the structure of information stored in each record of the text data manager database 421.

As shown in FIG. 6, each record in the text data manager database 421 contains a record identifier J12, serial number J11, print data, and printed text data.

The record identifier J12 is information identifying a specific record in the text data manager database 421. Because the record identifier J12 is a value unique to a specific record in the text data manager database 421, it can be used as information identifying the corresponding print data and corresponding printed text data.

In step SC2, the control server controller 40 generates the record identifier J12 according to a specific rule.

Next, the control server controller 40 stores a record relating the generated record identifier J12 to the received serial number J11, the print data, and the printed text data in the text data manager database 421.

After step SC2, the control server controller 40 references the layout information manager database 423 (described below), and determines if there is in the database a record having the same serial number J11 as the serial number J11 that was received (step SC3). The process of step SC3 is described below.

If such a record is not found (step SC3: NO), the control server controller 40 runs a text data extraction process (step SC4). Next, the control server controller 40, based on the result of the text data extraction process, generates a record in the layout information manager database 423 (step SC5), and creates a record in the transaction information manager database 422 (step SC6). The processes of step SC4 to step SC6 are described below.

If a matching record is found (step SC3: YES), the control server controller 40 acquires the layout information from that record (step SC7), generates analytical data based on the acquired layout information (step SC8), and based on the generated analytical data, creates a record in the transaction information manager database 422 (step SC9). The processes of steps SC7 to SC9 are described below together with the process of step SC3.

Steps SC4 to SC6 are described further below.

The text data analysis process of step SC4 is a process of itemizing the words or word groups (words and word groups are described further below) recorded in the printed text data, and generating analytical data (described further below) based on the itemized results.

Itemizing the words or word groups means identifying specific words or word groups in the words or word groups printed on a receipt as the itemized value corresponding to a predetermined item, and relating the word or word group identified as the itemized value of a specific item to that specific item.

For example, if there is an item that takes the store address information J2 as its value, the store address information J2 is found in the information contained in the printed text data, and relating that item to the identified store address information J2 is equivalent to itemizing a specific word or word group.

The text data analysis process is described below using the printed text data T1 shown in FIG. 5A, the printed text data T2 shown in FIG. 5B, and the following items as examples of items for itemizing. In this example, items to be extracted include a business address item of which the store address information J2 is the value; a business telephone number of which the store telephone number information J32 is the value; a receipt ID item of which the receipt identification information J42 is the value; a time stamp item of which the time stamp J5 is the value; a purchase quantity item of which the purchased quantity information J61 is the value; a product name item of which the product name information J62 is the value; a price item of which the price information J63 is the value; a subtotal item of which the subtotal information J72 is the value; a tax item of which the tax information J82 is the value; and a transaction total item of which the transaction total information J92 is the value.

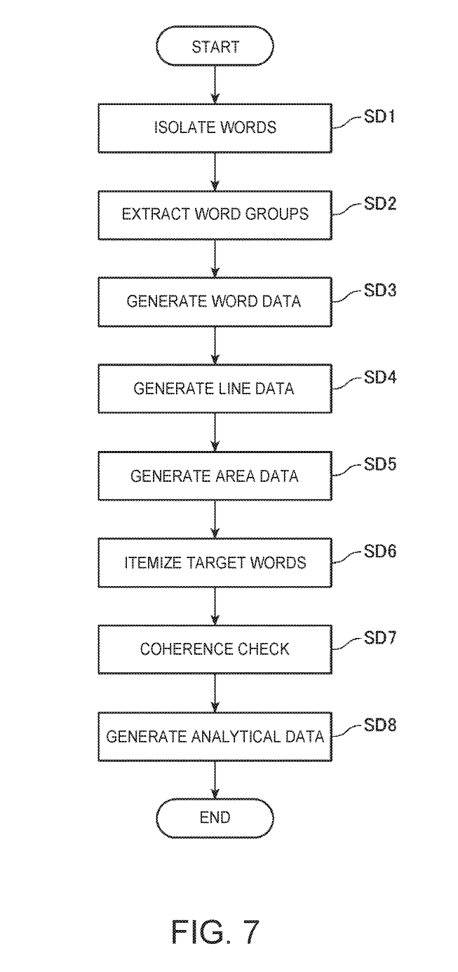

FIG. 7 is a flow chart of the text data analysis process.

Below, a control command representing a carriage return in the text data containing the printed text data is expressed as a CR (carriage return) character.

As shown in FIG. 7, the control server controller 40 separates the information contained in the printed text data into words (step SD1).

More specifically, the control server controller 40 breaks the information contained in the printed text data into individual words, a word being a continuous string (which may consist of a single character; a single character may also be referred to below as a “string”) of characters segmented (separated) by a break character in the printed text data. A continuous string of characters means one or more consecutive actual text characters on one line not containing any break characters. An actual text character is any character other than a break character.

In this exemplary embodiment of the invention, break characters include space characters and carriage return characters, and are stored in the control server storage unit 42.

The printed text data T1 shown in the example in FIG. 5A is broken into the following words at the break characters by the control server controller 40 in step SD1. Note that because white space between one character and another in the printed text data T1 in FIG. 5A and the printed text data T2 in FIG. 5B is a space character, and each line ends with a carriage return, the printed text data can be broken into individual characters.

The store address information J2 contains the word “1234”, the word “XXXStreet, New”, and the word “York”.

The telephone number identifier J31 contains the word “TEL”, and the store telephone number information J32 contains the word “12-345-678”.

The first area break information SK1 contains the word “--- . . . -”.

The receipt identification identifier J41 contains the word “Check#:”, and the receipt identification information J42 contains the word “C0001”.

The time stamp J5 contains the word “1/1/2015/12:00”.

The second area break information SK1 contains the word “--- . . . -”.

In the first line of detail information J6, the purchased quantity information J61 contains the word “1”, the product name information J62 contains the word “Beer”, and the price information J63 contains the word “10.00”.

In the second line of detail information J6, the purchased quantity information J61 contains the word ““1”, the product name information J62 contains the word “Toy”, and the price information J63 contains the word “60.00”.

The first second area break information SK2 contains the word “ - - - . . . -”

The subtotal identifier J71 contains the word “SUBTOTAL”, and the subtotal information J72 contains the word “70.00”.

The tax information identifier J81 contains the word “TAX”, and the tax information J82 contains the word “6.13”.

The transaction total identifier J91 contains the word “TOTAL”, and the transaction total information J92 contains the word “$76.13”.

The third area break information SK1 contains the word “--- . . . -”.

The additional information J10 contains the word “THANK”, and the word “YOU!”.

The printed text data T2 shown in the example in FIG. 5B is broken into the following words at the break characters by the control server controller 40 in step SD1.

The receipt identification identifier J41 contains the word “CheckNO.”, and the receipt identification information J42 contains the word “C0001”.

The time stamp J5 contains the word “1/1/2015/12:00”.

The first area break information SK1 contains the word “--- . . . -”.

In the first line of detail information J6, the product name information J62 contains the word “Beer”, the purchased quantity information J61 contains the word “1”, and the price information J63 contains the word “10.00”.

In the second line of detail information J6, the product name information J62 contains the word “Toy”, the purchased quantity information J61 contains the word ““1”, and the price information J63 contains the word “60.00”.

The subtotal identifier J71 contains the word “subtotal”, and the subtotal information J72 contains the word “70.00”.

The tax information identifier J81 contains the word “tax”, and the tax information J82 contains the word “6.13”.

The first third area break information SK3 contains the word “=== . . . =”.

The transaction total identifier J91 contains the word “total”, and the transaction total information J92 contains the word “$76.13”.

The first area break information SK1 contains the word “--- . . . -”.

The additional information J10 contains the word “THANK”, and the word “YOU!”.

The telephone number identifier J31 contains the word “tel”, and the store telephone number information J32 contains the word “12-345-678”.

The store address information J2 contains the word “1234”, the word “XXXStreet, New”, and the word “York”.

After step SD1, the control server controller 40 extracts specific plural words from among the words isolated by step SD1 into specific word groups each comprising specific plural words (step SD2). This is described below.

A word group is a group of plural words that together in combination form a single unit of meaning. In the printed text data T1 in FIG. 5A and the printed text data T2 in FIG. 5B, the words “1234,” “XXXStreet, New”, and “York” individually have no useful meaning. However, when these words are combined into the single word group “1234_XXXStreet, New_York” (where the underscore “_” represents a space character that is also a break character) they form a meaningful unit of information expressing the address of the store (business), that is, store address information J2. In this example, the combination “1234_XXXStreet, New_York” is extracted as a word group in step SD2.

In the printed text data T1 in FIG. 5A and the printed text data T2 in FIG. 5B, the words “THANK” and “YOU!” alone have no meaning, but when combined as the word group “THANK_YOU!” Form a meaningful unit of information as the additional information J10 expressing appreciation to the customer. In this example, the combination “THANK_YOU!” is extracted as a word group in step SD2.

The control server controller 40 may extract word groups based on the segmented words using the following method.

For example, the control server controller 40 executes the following process to extract the store address information J2. Words, such as “New_York” that may be used as words are previously registered in the control server storage unit 42 of the control server 15. A word may contain a space character. Rules for expressing an address are also registered in the control server storage unit 42 of thermal head control server 15. An address rule may, for example, state that addresses in a specific region may be expressed by a street address expressed by a number followed by a street name and information representing a geographical area.

If a string contains words that can be used in an address, and those words are preceded or followed by other words that follow the rules for expressing an address, the control server controller 40 determines that the string of words in information containing registered address words and following the rules for expressing an address are a word group related to the store address information J2.

Any desirable method may be used as the process extracting word groups.

After extracting word groups in step SD2, the control server controller 40 generates word data reflecting the word groups (step SD3). The word data contains the word groups extracted in step SD2, and other words not including the words in the word groups.

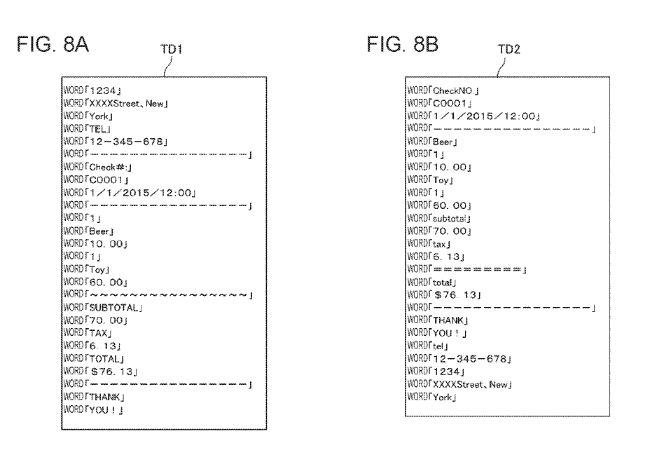

FIG. 8A shows an example of the word data TD1 extracted from the printed text data T1 in FIG. 5A. FIG. 8B shows an example of the word data TD2 extracted from the printed text data T2 in FIG. 5B.

The word groups extracted in step SD2 are referred to below as specific word groups. Of the words segmented in step SD1, the words other than the words contained in the specific word groups are referred to as “specific words.” “Target word” is used below when not differentiating between specific words and specific word groups.

After step SD3, the control server controller 40 breaks the target words into the lines in the printed text data by inserting carriage returns, and generates line data describing the relationship between the lines and the target words on each line (step SD4). More specifically, the printed text data is data comprising multiple lines of one or plural target words each. In step SD4, the control server controller 40 determines which target words are on which line, and generates line data describing the relationship between the line number and the target words on that line. Note that carriage returns are not included in the words or target words.

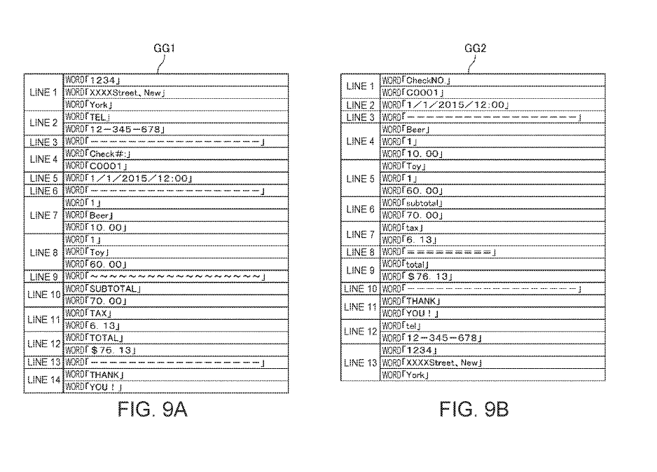

FIG. 9A illustrates the content of line data GG1, which is generated based on the printed text data T1 (FIG. 5A).

As shown in the line data GG1 in FIG. 9A, the words in the printed text data T1 shown in the example in FIG. 5A are separated into lines as shown below by the control server controller 40 in step SD2.

Line 1->word group “1234_XXXStreet, New_York”

Line 2->word “TEL”, word “12-345-678”

Line 3->word “--- . . . -”

Line 4->word “Check#:”, word “C0001”

Line 5->word “1/1/2015/12:00”

Line 6->word “--- . . . -”

Line 7->word “1”, word “Beer”, word “10.00”

Line 8->word “1”, word “Toy”, word “60.00”

Line 9->word “ - - - . . . -”

Line 10->word “SUBTOTAL”, word “70.00”

Line 11->word “TAX”, word “6.13”

Line 12->word “TOTAL”, word “$76.13”

Line 13->word “--- . . . -”

Line 14->word group “THANK_YOU!”

FIG. 9B illustrates the content of line data GG2, which is generated based on the printed text data T2 (FIG. 5B).

As shown in the line data GG2 in FIG. 9B, the words in the printed text data T2 shown in the example in FIG. 5B are separated into lines as shown below by the control server controller 40 in step SD2.

Line 1->word “CheckNO.”, word “C0001”

Line 2->word “1/1/2015/12:00”

Line 3->word “--- . . . -”

Line 4->word “Beer”, word “1”, word “10.00”

Line 5->word “Toy”, word “1”, word “60.00”

Line 6->word “subtotal”, word “70.00”

Line 7->word “tax”, word “6.13”

Line 8->word “=== . . . =”

Line 9->word “total”, word “$76.13”

Line 10->word “--- . . . -”

Line 11->word “THANK_YOU!”

Line 12->word “tel”, word “12-345-678”

Line 13->word “1234_XXXStreet, New_York”

Next, the control server controller 40 uses the area break information to separate the information contained in the printed text data into areas. The control server controller 40 then generates area data describing the areas and the relationship to the target words contained in each area, and the line to which each target word belongs (step SD5). This process is described below.

As described above, the receipt layout may change according to the POS system and the printer 12 that produces the receipts. The information printed on each receipt, however, is printed according to rules that do not change (referred to below as basic receipt rules) even if the POS system, printer 12, or receipt layout changes. Because the information related to a product purchase is printed on the receipt for the customer to see, or for proof of purchase, there are rules that have been standardized by custom. In other words, regardless of the layout, information is printed on each receipt according to the basic receipt rules.

One basic receipt rule is that the printing area on a receipt is divided by area break information, and the information printed on a receipt is separated into specific areas by the area break information. The reason for this is described below. That is, information with different attributes (different meaning) is printed on a receipt, including information about the store (business) where the customer made the purchase (such as logo information J1, store address information J2, store telephone number related information J3), information about the purchased products (such as detail information J6), information related to the receipt itself (such as receipt identification related information J4, time stamp J5), and information related to the customer's payment (such as subtotal related information J7, tax related information J8, transaction total related information J9). Breaking the printed area of a receipt into areas based on the area break information, and printing information with the same or similar attributes in each area, makes it easier for the customer reading the receipt to acquire the desired information from the receipt.

Another basic receipt rule is that area break information is information comprising the same special character (described below) printed plural times continuously on one line.

The special characters are any characters that can function suitably as area break information, and in this example are the hyphen (-), tilde (˜), and equal sign (=) characters. The special characters are not limited to these examples, however, and characters such as @, *, and + may be used, for example.

Another basic receipt rules is that no information other than the area break information is printed on the same line as area break information.

Information indicating the special characters that may be used as the characters in the area break information is stored in the control server storage unit 42 of thermal head control server 15. In step SD5, the control server controller 40 identifies as area break information any information containing at least a specific number of the registered special characters printed continuously on one line that are extracted as a specific word with no other information included on the same line.

Next, the control server controller 40 identifies in the printed text data the areas delimited by the identified one or plural area break information. Next, the control server controller 40 identifies the target words in each area, and generates area data describing the relationship between each area and the target words in each area, together with the line to which the target words belong (step SD5).

The areas segmented by the area break information in the printed text data are referred to below as the first area, second area, to n-th area, starting from the top of the receipt.

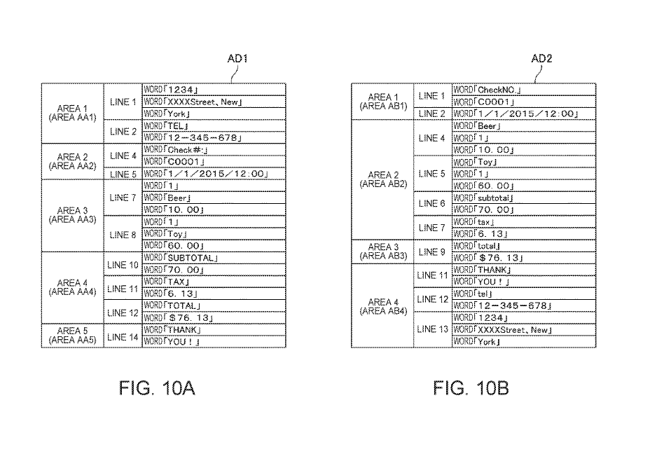

FIG. 10A shows an example of the content of the area data AD1 generated based on the printed text data T1 (FIG. 5A).

Based on the printed text data T1, the control server controller 40 identifies as area break information: the word “--- . . . -” associated with the first instance of area break information SK1; the word “--- . . . -” associated with the second instance of area break information SK1; the word “˜ ˜ ˜ . . . ˜” associated with the first instance of second area break information SK2; and the word “--- . . . -” associated with the third instance of area break information SK1. Next, the control server controller 40 separates the printed text data T1 into areas using the identified area break information, and identifies the target words in each area. Next, the control server controller 40 generates area data AD1 as shown in the example in FIG. 10A based on the relationships between the areas and the target words in each area.

FIG. 10B shows an example of the content of the area data AD2 generated based on the printed text data T2 (FIG. 5B).

Based on the printed text data T2, the control server controller 40 identifies as area break information: the word “--- . . . -” associated with the first instance of area break information SK1; the word “=== . . . =” associated with the first instance of third area break information SK3; and the word “--- . . . -” associated with the second instance of area break information SK1. Next, the control server controller 40 separates the printed text data T2 into areas using the identified area break information, and identifies the target words in each area. Next, the control server controller 40 generates area data AD2 as shown in the example in FIG. 10B based on the relationships between the areas and the target words in each area.

After step SD5, the control server controller 40 groups the target words into items based on the printed text data, word data, line data, and area data (step SD6). As described above, itemizing the target words means identifying, for specific target words in the list of target words, the item value corresponding to a specific item in the group of predetermined items, and relating the item value to the specific item. Step SD6 is described more specifically below with examples.

The “data type” of words in the printed text data is defined as follows. Specifically, the data type of words expressing a numeric value without a decimal point, or words expressing a numeric value with a decimal point, is defined as numeric. For example, the word “1” and the word “10.00” are both words of the numeric type.

The data type of words containing numeric information and including a currency symbol or currency unit is defined as currency. For example, the word “$76.13” is a word of the type currency.

The data type of words containing numeric information and including a character representing a unit other than a currency symbol or unit is defined as a unit. For example, the word “@1” is a word of the type unit.

The data type of a word that is not of the numeric, currency, or unit type, and contains at least one character other than characters representing a number, characters representing a unit, and characters representing symbols is defined as text.

The control server controller 40 itemizes the words corresponding to the purchased quantity information J61, product name information J62, and price information J63 by the method described below. More specifically, the control server controller 40 determines which of the target words are purchased quantity information J61, which target words are product name information J62, and which target words are price information J63, and relates those target words to the respective items.

There is a basic receipt rule that the purchased quantity information J61, product name information J62, and price information J63 related to a product of a single type is printed on one line regardless of the receipt layout. This is because this information is printed on every receipt, and by printing the information on one line, the information is shown to be information related to the product of the one type. Furthermore, by printing this information on one line, the relationship between the purchased quantity information J61, product name information J62, price information J63 is obvious when the detail information J6 contains multiple products (that is, multiple lines).

Another basic receipt rule is that when multiple lines of detail information J6 containing purchased quantity information J61, product name information J62, price information J63 are printed on a receipt, each line of detail information J6 is printed in the same area. This is because each line of detail information J6 is information with the same attribute.

Another basic receipt rule is that the purchased quantity information J61 is a word of the numeric or unit type, the product name information J62 is a word of the text type, and the price information J63 is a word of the numeric or currency type.

Based on the above, the control server controller 40, based on the line data, identifies one or more lines containing a target word of numeric or unit type, a target word of text type, and a target word of numeric or currency type on the same line regardless of the order in which they appear. A “line” identified here is the same as a line containing the detail information J6. The control server controller 40 extracts the target word of the text type in the selected line as the product name information J62, and the item value corresponding to the purchased product name item.

The control server controller 40 also determines if target words of the numeric or unit type, and target words of the numeric or currency type, on the extracted line are purchased quantity information J61 or price information J63. For example, the control server controller 40 determines that target words of the currency type are price information J63. The control server controller 40 determines that target words of the unit type are purchased quantity information J61. If the two target words are both words of the numeric type, the control server controller 40 determines which target word contains the purchased quantity information J61 and which target word contains the price information J63 based on the size of the values indicated by the two target words, or the relationship to the values represented by two target words on another line of detail information J6.

The control server controller 40 relates the target word identified as the purchased quantity information J61 as the purchased quantity item, the target word identified as the product name information J62 as the product name item, and the target word identified as the price information J63 as the unit price item.

The control server controller 40 itemizes the purchased quantity information J61, product name information J62, price information J63 based on the relative positions of the words (that the words are printed on the same line) and the data types of the words. By itemizing the content based on these words as described above, the content can be appropriately itemized regardless of the layout of the receipt.

The control server controller 40 itemizes the words corresponding to the tax information J82 and transaction total information J92 as described below.

Another basic receipt rule is that the subtotal information J72, tax information J82, and transaction total information J92 are printed in this order. This is because the subtotal is calculated, the tax is calculated based on the subtotal, and the transaction total is the sum of the subtotal and the tax. For example, when this information is printed on separate lines, the subtotal information J72, tax information J82, and transaction total information J92 are printed sequentially in this order from top to bottom. If at least two of these values are printed on the same line, the subtotal information J72, tax information J82, and transaction total information J92 is printed sequentially from left to right on the same line.

Another basic receipt rule is that the subtotal information J72, tax information J82, and transaction total information J92 are printed in the same area, or are printed in adjacent areas. This is because this information is information with the same attribute, and by printing the information close together, the relationship therebetween can be easily understood.

Another basic receipt rule is that the subtotal information J72 is printed on the receipt beside the subtotal identifier J71. This is because the data type of the word corresponding to the subtotal information J72 is numeric or currency, and the meaning of the subtotal information J72 is identified by the subtotal identifier J71. Another basic receipt rule is that the data type of the word corresponding to the subtotal information J72 is numeric or currency, and the data type of the word corresponding to the subtotal identifier J71 is text.

Another basic receipt rule is that the tax information J82 is printed on the receipt beside the tax information identifier J81. This is because the data type of the word corresponding to the tax information J82 is numeric or currency, and the meaning of the tax information J82 is identified by the tax information identifier J81. Another basic receipt rule is that the data type of the word corresponding to the tax information J82 is numeric or currency, and the data type of the word corresponding to the tax information identifier J81 is text.

Another basic receipt rule is that the transaction total information J92 is printed on the receipt beside the transaction total identifier J91. This is because the data type of the word corresponding to the transaction total information J92 is numeric or currency, and the meaning of the transaction total information J92 is identified by the transaction total identifier J91. Another basic receipt rule is that the data type of the word corresponding to the transaction total information J92 is numeric or currency, and the data type of the word corresponding to the tax transaction total identifier J91 is text.

Following the basic receipt rules related to the subtotal information J72, tax information J82, and transaction total information J92, the control server controller 40 itemizes the words corresponding to this information based on the printed text data, word data, line data, and area data.

The control server controller 40 processes the subtotal information J72 as described below, for example.

Words that can be contained in the subtotal identifier J71 are previously registered in the control server storage unit 42 of thermal head control server 15. Based on the registered words, the control server controller 40 extracts candidates for the target words corresponding to the subtotal identifier J71. Because the data type of the word corresponding to the subtotal identifier J71 is text; the word corresponding to the subtotal identifier J71 is adjacent to the word corresponding to the subtotal information J72; the word corresponding to the subtotal identifier J71 is located before the word corresponding to the tax information identifier J81; and the word corresponding to the subtotal identifier J71 is in the same area as or adjacent to the area of the tax information identifier J81 or transaction total identifier J91; the control server controller 40 identifies the target word corresponding to the subtotal identifier J71 from the extracted candidates based on the printed text data, word data, line data, and area data. Next, based on the position relative to the subtotal identifier J71, the position relative to words other than the subtotal identifier J71, and the data type, the control server controller 40 identifies the target word corresponding to the subtotal information J72, and relates the identified target word to the subtotal item.

Using the same method used to itemize the target words of the subtotal information J72, the control server controller 40 relates the target words corresponding to the tax information J82 to the tax item, and relates the target words corresponding to the transaction total information J92 to the transaction total item.

As described above, the control server controller 40 itemizes the target words corresponding to the subtotal information J72, tax information J82, and transaction total information J92 based on the relative positions of the words, the positions of the words relative to other words, and the data types of the words. By grouping the words into specific items as described above, receipt content can be appropriately itemized regardless of the layout of the receipt.

The control server controller 40 breaks the store address information J2 into items of target words (target words related to a word group in this example) corresponding to the store address information J2.

More specifically, the target words corresponding to the store address information J2 contain, as described above, words that can be used in an address and information following rules for writing an address. One basic receipt rule is that the store address information J2 is printed in a different area than the areas where the detail information J6, subtotal related information J7, tax related information J8, and transaction total related information J9 are printed. This is because the store address information J2 is information with different attributes than the detail information J6, subtotal related information J7, tax related information J8 and transaction total related information J9. Based on the content of the target words, the control server controller 40 extracts candidates for words corresponding to the store address information J2 from the target words. Based on location of the candidate target words to the target words of the detail information J6, subtotal related information J7, tax related information J8 and transaction total related information J9, the control server controller 40 identifies the target words corresponding to the store address information J2 from the extracted candidates. Next, the control server controller 40 correlates the identified target words to the business address items.

As described above, the control server controller 40 itemizes the target words corresponding to the store address information J2 based on the relative positions of the words to other target words. By grouping the words into specific items as described above, receipt content can be appropriately itemized regardless of the layout of the receipt.

The control server controller 40 breaks the receipt identification information J42 into items of target words corresponding to the information by the method described below.

A basic receipt rule is that the receipt identification information J42 is printed on the receipt adjacent to the receipt identification identifier J41. This is because the receipt identification information J42 alone has no meaning, and the meaning of the receipt identification information J42 is identified by the receipt identification identifier J41. Another basic receipt rule is that the receipt identification information J42 is printed in a different area than the areas where the detail information J6, subtotal related information J7, tax related information J8, and transaction total related information J9 are printed. This is because the receipt identification information J42 is information with different attributes than the detail information J6, subtotal related information J7, tax related information J8 and transaction total related information J9.

Words that can be contained in the receipt identification identifier J41 are previously registered in the control server storage unit 42 of thermal head control server 15. Based on the registered words, the control server controller 40 extracts candidates for the target words corresponding to the receipt identification identifier J41. Based on the basic receipt rules related to the receipt identification information J42 described above, the control server controller 40 identifies the target words corresponding to the receipt identification identifier J41 from the extracted candidates based on the printed text data, word data, line data, and area data. Next, based on the position relative to the receipt identification identifier J41, the position relative to words other than the receipt identification identifier J41, the control server controller 40 identifies the target word corresponding to the receipt identification information J42, and relates the identified target word to the receipt identification identifier J41.

As described above, the control server controller 40 itemizes the target words corresponding to the receipt identification related information J4 based on the relative positions to other words. By grouping the words into specific items as described above, receipt content can be appropriately itemized regardless of the layout of the receipt.

The control server controller 40 itemizes the words corresponding to the time stamp J5 as described below.

The time stamp J5 is written in a format following specific rules for expressing the date and time. One basic receipt rule is that the time stamp J5 is printed in a different area than the areas where the detail information J6, subtotal related information J7, tax related information J8, and transaction total related information J9 are printed. This is because the time stamp J5 is information with different attributes than the detail information J6, subtotal related information J7, tax related information J8 and transaction total related information J9. Based on the content of the target words, the control server controller 40 extracts candidates for words corresponding to the time stamp J5 from the target words. Based on the location of the candidate target words to the target words of the detail information J6, subtotal related information J7, tax related information J8 and transaction total related information J9, the control server controller 40 identifies the target words corresponding to the time stamp J5 from the extracted candidates. Next, the control server controller 40 correlates the identified target words to the time stamp item.

As described above, the control server controller 40 itemizes the target words corresponding to the time stamp J5 based on the relative positions of the words to other target words. By grouping the words into specific items as described above, receipt content can be appropriately itemized regardless of the layout of the receipt.

A process of itemizing words or word groups is described above, but the method of grouping words or word groups into specific items is not so limited. The items of objects related by words or word groups are also not so limited, and the information contained in the printed text data is not limited to the foregoing examples.

As shown in FIG. 7, after step SD6, the control server controller 40 applies a coherence check (step SD7).

More specifically, the transaction total of the transaction, the subtotal, and the tax are related as described below. Specifically, the transaction total=subtotal+tax. Based thereon, the control server controller 40 determines if the numeric value (subtotal) expressed by the target word related to the subtotal item (the target word corresponding to the subtotal information J72), the numeric value (tax) expressed by the target word related to the tax item (the target word corresponding to the tax information J82), and the numeric value (transaction total) expressed by the target word related to the transaction total item (the target word corresponding to the transaction total information J92), are in the relationship described above. If not so related, the control server controller 40 determines that itemizing the target words failed and runs an appropriate process. For example, the control server controller 40 may, by a specific method, report to the operator or other authorized person that itemizing the target words may have failed.

The subtotal of a transaction is the sum of the products of the product price multiplied by the product quantity for each product purchased by the customer. Based thereon, the control server controller 40 determines if the sum of the numeric value expressed by the target word related to the unit price item (the target word corresponding to price information J63) and the numeric value expressed by the target word corresponding to the purchased quantity item (the target word corresponding to purchased quantity information J61), and the numeric value (subtotal) expressed by the target word corresponding to the subtotal item (the target word corresponding to subtotal information J72), is in the relationship described above. If this relationship is not true, the control server controller 40 executes an appropriate handling process.

Based on the result of step SD7, the control server controller 40 generates analytical data (step SD8), and ends the text data analysis process.

The analytical data is text data containing the items in a hierarchical structure. The analytical data may be in an XML format or JSON format, for example.

In step SD8, the control server controller 40 generates analytical data relating items and corresponding target words for each item correlated to a target word in the process of step SD6.

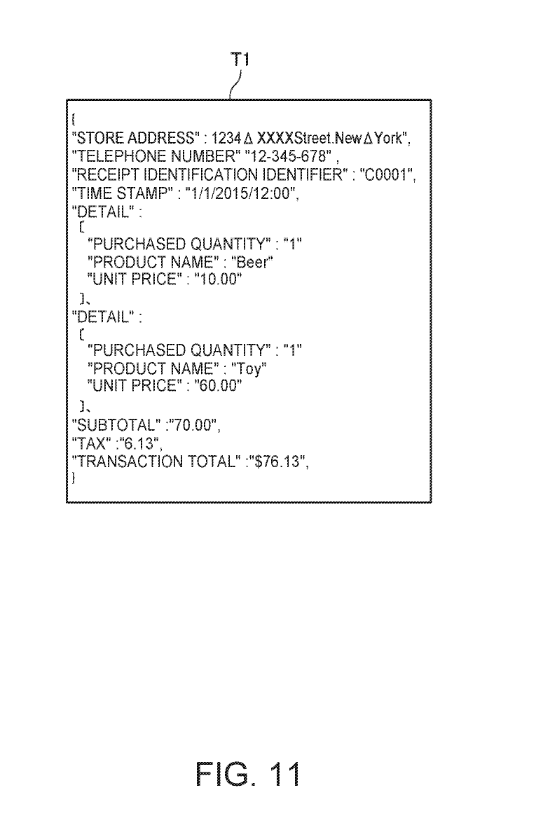

FIG. 11 illustrates the content of the analytical data BS1 generated based on the printed text data T1 (FIG. 5A) in a format appropriate to description.

As shown in FIG. 11, the analytical data based on the printed text data T1 comprises item values correlated to each item, that is, the business address, telephone number, receipt identifier, time stamp, purchased quantity, product names, unit price, subtotal, tax, and transaction total.

As shown in FIG. 3, column (C), after the text data analysis process in step SC4, the control server controller 40 registers one record in the layout information manager database 423 based on the result of the text data analysis process (step SC5).

More specifically, in step SC5, the control server controller 40 generates layout information based on the word data, line data, and area data generated in the text data analysis process. The layout information is information describing, based on the printed text data, which items are recorded in which areas in what format. Based on the layout information, the control server controller 40 can itemize the target words in the printed text data. The layout information also contains information enabling the control server controller 40 to group the target words in the printed text data into specific items based on the layout information.

After generating the layout information, the control server controller 40 records in the layout information manager database 423 one record relating the serial number J11 received in step SC1 to the generated layout information.

In the next step SC6, the control server controller 40 records one record in the transaction information manager database 422 based on the analytical data.

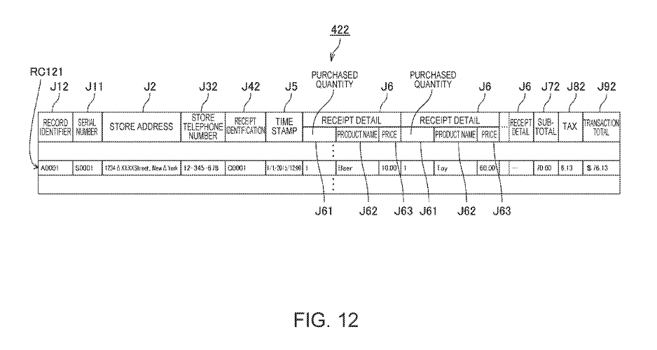

FIG. 12 illustrates the data structure of the transaction information manager database 422.

As shown in FIG. 12, each record in the transaction information manager database 422 contains a record identifier J12 and a serial number J11. The transaction information manager database 422 also stores store address information J2 (the item value of the store address information item), store telephone number information J32 (the item value of the store telephone number information item), receipt identification information J42 (the item value of the receipt identification information), time stamp J5 (the item value of the time stamp item), subtotal information J72 (the item value of the subtotal information item), tax information J82 (the item value of the tax information item), and transaction total information J92 (the item value of the transaction total information item). Each record in the transaction information manager database 422 also stores detail information J6 for each product purchased by the customer. Each detail information J6 record contains the purchased quantity information J61 (the item value of the purchased quantity information item), product name information J62 (the item value of the product name information item) m and price information J63 (the item value of the price information item).

In FIG. 12, record RC121 is an example of a record generated based on the printed text data T1.

In step SC6, the control server controller 40 acquires the item value for each item from the analytical data, and stores the acquired item values in the appropriate fields of the newly generated record.

As described above, in step SC3, the control server controller 40 references the layout information manager database 423 (described below), and determines if in the database there is a record containing a serial number J11 with the same value as the value of the serial number J11 received in step SC1.

As described above, if the printer 12 that transmitted the print data or other data has previously run the text data analysis process, there may be a record in the layout information manager database 423 relating the serial number J11 of that printer 12 to layout information.

If there is a record in the layout information manager database 423 storing a serial number J11 with the same value as the serial number J11 received in step SC1 (step SC3: YES), the control server controller 40 acquires the layout information from that record (step SC7).

Next, the control server controller 40 generates analytical data based on the printed text data received in step SC1 and the layout information acquired in step SC7 (step SC8). As described above, the layout information contains the required information enabling the control server controller 40 to itemize the target words in the printed text data based on the layout information.

Next, the control server controller 40, based on the analytical data generated in step SC8, creates a record in the layout information manager database 423 (step SC9).

As described above, a record is created in the transaction information manager database 422 for each transaction according to the transaction completed in the store. Each record in the transaction information manager database 422 contains valuable information that is printed on the receipt, including information related to the produced purchased by the customer (detail information J6), and information related to payment by the customer (subtotal information J72, tax information J82, transaction total information J92). Therefore, based on the transaction information manager database 422, the control server 15 can provide in response to queries information that is useful for management of the store or business, including information related to sales in a particular store, or information related to the products that are purchased in a particular store.

As described above, in this exemplary embodiment of the invention the control server 15 processes printed text data (text data) containing as text the information that is printed. The control server controller 40 (control unit) of the control server 15 breaks the information contained in the printed text data into words, and based on the relative positions of the words, groups the words into items comprising words or word groups of multiple words.

This configuration breaks the information contained in the printed text data into words, and the resulting words or word groups are appropriately itemized based on the relative positions of the words in the printed text data. As a result, after correlating the words or word groups to specific items and item values, the words or word groups can be interpreted and used as item values corresponding to specific items, and the printed information can be appropriately analyzed.

The control server controller 40 in this exemplary embodiment of the invention also groups the words or word groups into items based on the relative positions of the words and the data type of the words.

This configuration enables using the data type of words to more appropriately group the words or word groups into items.

The control server controller 40 in this embodiment, based on the results of itemizing the words or word groups, generates analytical data organizing the items hierarchically, and relating each item to the words or word groups containing the corresponding item value.

This configuration enables later using the analytical data to run processes using the itemized words or word groups.

The printed text data in this exemplary embodiment of the invention is data containing information printed according to a specific layout written according to the specific layout. Based on the results of itemizing the words or word groups, the control server controller 40 generates layout information, which is information related to the specific layout corresponding to the printed text data, and is information that can be used for itemizing the words or word groups contained in the printed text data associated with the specific layout.

After generating the layout information, this configuration enables easily itemizing the words or word groups based on the layout information.

As described in the coherence check of step SD7, when the item value of one item and the item value of another item are in a specific relationship and the coherence of the one item and other item is confirmed, the control server controller 40 itemizes the words or word groups, and then determines if the words or word groups identified as the item value of the one item, and the words or word groups identified as the item value of the other item, are in a specific relationship.

As a result, the control server controller 40 can detect when the words or word groups are not correctly itemized.

The control server controller 40 in the example embodiment described above breaks the printed text data into words using specific break characters as separators.

This configuration enables using break characters to correctly separate information containing printed text data into words.

### OTHER EMBODIMENTS

In the example embodiment described above the control server 15 runs the text data analysis process. However, the device that runs the text data analysis process is not limited to the control server 15, and may be the printer 12. In this event, the printer 12 functions as an information processing device, and the printer controller 30 that executes the process functions as the control unit.

The invention is described above with reference to exemplary embodiments thereof, but the invention is not limited thereto and can be modified and adapted in many ways without departing from the scope of the accompanying claims.

For example, when the control method of the control server 15 (control method of the information processing device) is implemented by a computer of the control server 15 or using an external device connected to the control server 15, the invention may be embodied as a program the computer executes to implement the control method, a computer-readable recording medium storing the program, or a transmission medium that transmits the program. The recording medium may be a magnetic or optical recording medium, or a semiconductor memory device. More specifically, the recording medium may be a floppy disk, HDD (Hard Disk Drive), CD-ROM (Compact Disk Read Only Memory), DVD (Digital Versatile Disk), Blu-ray® Disc, magneto-optical disc, flash memory, memory card media, or other type of removable or fixed recording medium. Further alternatively, the recording medium may be RAM (random access memory), ROM (read-only memory), hard disk drive, or other nonvolatile internal storage medium of the control server 15 or external device connected to the control server 15.

Further alternatively, in the embodiment described above the printer 12 generates printed text data based on the print data appropriate to a transaction. However, a configuration in which the control server 15 receives print data from the printer 12, and generates printed text data based on the received print data, is also conceivable.

Furthermore, specific examples of the information stored in the transaction information manager database 422 and the layout information manager database 423 are described above, but the information stored in the databases is not so limited.

Furthermore, in the example embodiment described above the printer 12 and the tablet terminal 13 functioning as a host computer communicate wirelessly. However, communication between the printer 12 and host computer is not limited to wireless communication, and configurations that use a wired LAN communication protocol, or wired communication using a serial communication protocol such as USB or other serial standard, or a parallel communication standard, are possible. The host computer is also not limited to a tablet device such as the tablet terminal 13, and may be configured as a desktop device.

Exemplary embodiments of the invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. An information processing device comprising:
a communicator configured to communicate with a printing device; and
a controller configured to:
generate words from text data received from the communicator based on break characters contained in the text data,
generate word groups containing multiple words based on the relative positions before and after the words, and
group the words or word groups into items based on the relative positions of the words or word groups,
wherein the text data contains print information that is printed by the printing device.

2. The information processing device described in claim 1, wherein:
the text data contains receipt information that is printed as a receipt by the printing device,
the information processing device includes a storage configured to store specific rules for itemizing the words or word groups based on the receipt, and
the controller itemizes the words or word groups based on the rules stored in the storage.

3. The information processing device described in claim 1, wherein:
the controller itemizes the words or word groups based on respective data types of the words.

4. The information processing device described in claim 1, wherein:
based on the result of itemizing the words or word groups, the controller generates analytical data relating the words or word groups to items and item values in a hierarchy of items.

5. The information processing device described in claim 1, wherein:
the text data is data written according to a specific layout, and
the controller generates layout information based on the result of itemizing the words or word groups,
the layout information being information related to a specific layout corresponding to the text data, and being information that can be used to itemize the words or word groups of the text data in the specific layout.

6. The information processing device described in claim 1, wherein:
after itemizing the words or word groups, the controller determines if the words or word groups related as the item value of one item, and the words or word groups related to the item value of another item, are in a specific relationship.

7. The information processing device described in claim 1, wherein:
the controller itemizes the words or word groups based on the position in the line to which the words or word groups belong.

8. An information processing system comprising:
a printing device performing a printing function, and transmitting text data containing print information to be printed, and
an information processing device configured to receive the text data from the printing device, and having:
a controller configured to generate words from the text data received from the printing device based on break characters contained in the text data,
generate word groups containing multiple words based on relative positions before and after the words, and
group the words or word groups into items based on the relative positions of the words or word groups.

9. A control method of an information processing device that can communicate with a printing device, comprising:
receiving text data from the printing device;
generating words based on break characters contained in the text data;
generating word groups containing multiple words based on the relative positions before and after the words; and
grouping the words or word groups into items based on relative positions of the words or word groups,
wherein the text data contains print information that is printed by the printing device.

10. The control method of an information processing device described in claim 9, wherein:
the text data contains receipt information that is printed as a receipt by the printing device; and
the words or word groups are itemized based on the receipt according to specific rules for itemizing the words or word groups.

11. The control method of an information processing device described in claim 9, further comprising:
itemizing the words or word groups based on respective data types of the words.

12. The control method of an information processing device described in claim 9, further comprising:
based on a result of grouping the words or word groups into items, generating analytical data relating the words or word groups to items and item values in a hierarchy of items.

13. The control method of an information processing device described in claim 9, wherein:
the text data is data written according to a specific layout, and
the control method including generating layout information based on the result of further grouping the words or word groups,
the layout information being information related to a specific layout corresponding to the text data, and being information that can be used to itemize the words or word groups of the text data in the specific layout.

14. The control method of an information processing device described in claim 9, further comprising:
after grouping the words or word groups, determining if the words or word groups related item value of one item, and the words or word groups related to the item value of another item, are in a specific relationship.

15. The control method of an information processing device described in claim 9, further comprising:
itemizing the words or word groups based on a position in a line to which the words or word groups belong.
